(19) United States
(12) Patent Application Publication
(10) Pub. No.: US 2010/0055298 A1
(43) Pub. Date: Mar. 4, 2010

(54) PROCESS KIT SHIELDS AND METHODS OF USE THEREOF

(75) Inventors: Joseph F. Sommers, San Jose, CA (US); Keith A. Miller, Sunnyvale, CA (US)

Correspondence Address: MOSER IP LAW GROUP / APPLIED MATERIALS, INC., 1030 BROAD STREET, 2ND FLOOR, SHREWSBURY, NJ, 07702, US

(73) Assignee: APPLIED MATERIALS, INC., Santa Clara, CA (US)

(21) Appl. No.: 12/200,141

(22) Filed: Aug. 28, 2008

(51) Int. Cl. B05D 5/12

(52) U.S. Cl. 427/58; 118/719; 118/70; 134/41

(57) ABSTRACT

Process kit shields for use in a process chamber and methods of use thereof are provided herein. In some embodiments, the process kit shield may include a body having a wall comprising a first layer and a second layer bonded to the first layer, wherein the first layer comprises a first material resistant to a cleaning chemistry utilized to remove material disposed on the first layer during processing, and wherein the second layer comprises a second material different than the first material and having a coefficient of thermal expansion substantially similar to that of the first material. In some embodiments, the process kit shield may be disposed in a process chamber having a processing volume and a non-processing volume. The process kit shield may be disposed between the processing volume and the non-processing volume

### BACKGROUND OF THE INVENTION

1. Field of the Invention

Embodiments of the present invention generally relate to semiconductor equipment and more particularly, to process kit shields used in semiconductor process chambers.

2. Description of the Related Art

A process kit shield is a consumable component, typically used to extend the lifetime of a semiconductor process chamber or other chamber component such as, for example, a substrate support. Typically, a process kit shield is constructed from a material having high thermal conductivity, reduced weight, and low cost. Such materials may include, for example, aluminum, stainless steel, or titanium. During most semiconductor processes, metallic and non-metallic materials are generated including materials such as tantalum (Ta), tungsten (W), titanium (Ti), silicon (Si), organics, polymers, and the like, which may be deposited on a surface of the process kit shield. In order to prevent contamination by the deposited materials flaking off of the process kit shield and depositing onto the substrate being processed in the chamber, the process kit shield must effectively retain the deposited material and be periodically cleaned. Unfortunately, the removal of the deposited materials requires the use of aggressive chemical treatments, for example, hydrofluoric acid (HF) or other caustic chemicals, or mechanical removal by blasting with abrasive materials such as alumina grit. Such treatments erode the surface of the process kit shield while removing the deposited particles. As such, the lifetime of the process kit shield is significantly reduced.

Accordingly, there is a need in the art for process kit shields with improved lifetimes.

### SUMMARY OF THE INVENTION

Process kit shields for separating a processing volume from a non-processing volume in a process chamber and methods of use thereof are provided herein. In some embodiments, the process kit shield may include a body having a wall comprising a first layer and a second layer bonded to the first layer, wherein the first layer comprises a first material resistant to a cleaning chemistry utilized to remove material disposed on the first layer during processing, and wherein the second layer comprises a second material different than the first material and having a coefficient of thermal expansion substantially similar to that of the first material.

In some embodiments, an apparatus for processing a substrate may include a process chamber having a processing volume and a non-processing volume; and a process kit shield disposed in the chamber and separating the processing volume from the non-processing volume, the process kit shield comprising a body having a wall comprising a first layer that faces the processing volume and a second layer that faces the non-processing volume, wherein the second layer is bonded to the first layer, wherein the first layer comprises a first material resistant to a cleaning chemistry utilized to remove material disposed on the first layer during processing, and wherein the second layer comprises a second material different than the first material and having a coefficient of thermal expansion substantially similar to that of the first material.

In some embodiments, a method of processing a substrate may include providing a process chamber having a processing volume and a non-processing volume and having a process kit shield disposed in the chamber and separating the processing volume from the non-processing volume, the process kit shield comprising a body having a wall comprising a first layer that faces the processing volume and a second layer that faces the non-processing volume, wherein the second layer is bonded to the first layer, wherein the first layer comprises a first material resistant to a cleaning chemistry utilized to remove material disposed on the first layer during processing, and wherein the second layer comprises a second material different than the first material and having a coefficient of thermal expansion substantially similar to that of the first material; placing a substrate in the process chamber; forming a plasma in the processing volume; and exposing the substrate to the plasma.

In some embodiments, a method of cleaning a process kit shield may include providing a process kit shield comprising a body having a wall comprising a first layer and a second layer bonded to the first layer, wherein the first layer comprises a first material resistant to a cleaning chemistry utilized to remove material disposed on the first layer during processing, wherein the second layer comprises a second material different than the first material and having a coefficient of thermal expansion substantially similar to that of the first material, and wherein the first layer has contaminants disposed thereon; and exposing the first layer to the cleaning chemistry to remove the contaminants.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts an apparatus for processing a substrate in accordance with some embodiments of the present invention.

FIG. 2 depicts a partial cross sectional view of a process kit shield in accordance with some embodiments of the present invention.

FIG. 3 depicts a flow chart of a method for processing a substrate in accordance with some embodiments of the present invention.

FIG. 4 depicts a flow chart of a method for cleaning a process kit shield in accordance with some embodiments of the present invention.

The drawings have been simplified for clarity and are not drawn to scale. To facilitate understanding, identical reference numerals have been used, wherever possible, to designate identical elements that are common to the figures. It is contemplated that some elements of one embodiment may be beneficially incorporated in other embodiments without further recitation.

### DETAILED DESCRIPTION

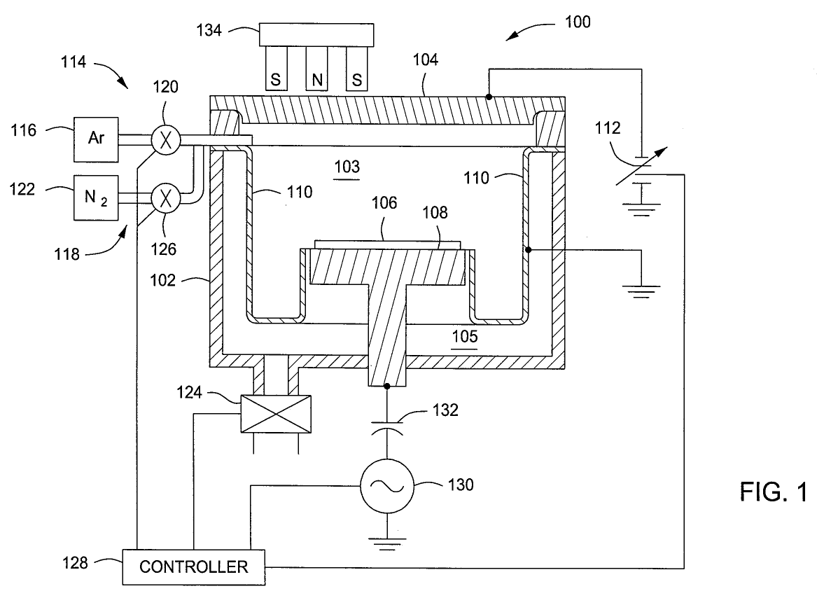

Methods and apparatus for process kit shields are provided herein. In some embodiments, a process kit shield may include a first layer comprising a first material resistant to a process gas in a processing region and a second layer comprising a second material having a coefficient of thermal expansion (CTE) substantially similar to the first material. The inventive process kit shield may advantageously be constructed inexpensively from a combination of materials (i.e., the first and second materials) providing the desired weight, thermal properties, and resistance to chemical cleaning treatments, thus increasing process kit lifetime. The inventive process kit shield may be utilized in a semiconductor process apparatus (e.g., a process chamber) such as illustrated in FIG. 1.

FIG. 1 depicts a schematic cross-sectional view of an apparatus 100 for processing a substrate and having a process kit shield 110 in accordance with some embodiments of the present invention. The apparatus 100 may be configured for high density plasma physical vapor deposition (HDPPVD) and may be of a type sometimes referred to as a self ionizing plasma (SIP™) chamber, available from Applied Materials, Inc. of Santa Clara, Calif. The apparatus 100 is merely exemplary, and other suitable apparatus, such as process chambers configured for chemical vapor deposition (CVD), physical vapor deposition (PVD), etch, ion implantation and other processes that may result in undesirable deposition of particles on chamber components, may be utilized with the process kit shield of the present invention. In some embodiments, another suitable apparatus may include a process chamber configured for chemical mechanical planarization (CMP).

The apparatus 100 includes a process chamber 102 having a processing volume 103, a non-processing volume 105 and a support pedestal 108 disposed therein for supporting a substrate 106 during processing. In some embodiments, such as when configured for PVD applications, a target 104 may be installed proximate the top of the chamber 102. The target 104 may comprise a material to be sputter deposited on the substrate 106 disposed on the substrate support pedestal 108. Illustrative target materials may include tantalum (Ta), tungsten (W), titanium (Ti), nickel (Ni), cobalt (Co), germanium (Ge), antimony (Sb), tellurium (Te), alloys thereof, or the like. In some embodiments, the process chamber 102 may further include a mechanism for forming a plasma such as, for example, by self-ionization of the target material by ions generated from the target material, as discussed in more detail below.

The process kit shield 110 may be disposed in the process chamber 102 and positioned to separate the processing volume 103 from the non-processing volume 105. The process kit may be any suitable shape desired to separate a processing volume from a non-processing volume. For example, in some embodiments, and as illustrated in FIG. 1, the process kit shield 110 can have an annular shape and may have a base that circumscribes a perimeter of the support pedestal 108. The process kit shield 110 may protect the walls and other non-processing portions of the chamber from processing by-products, such as material sputtered from the target 104, deposition gas by-products, or the like. The process kit shield 110 may further act as a grounding anode when DC power is applied to the target 104 by a variable (DC) power supply 112.

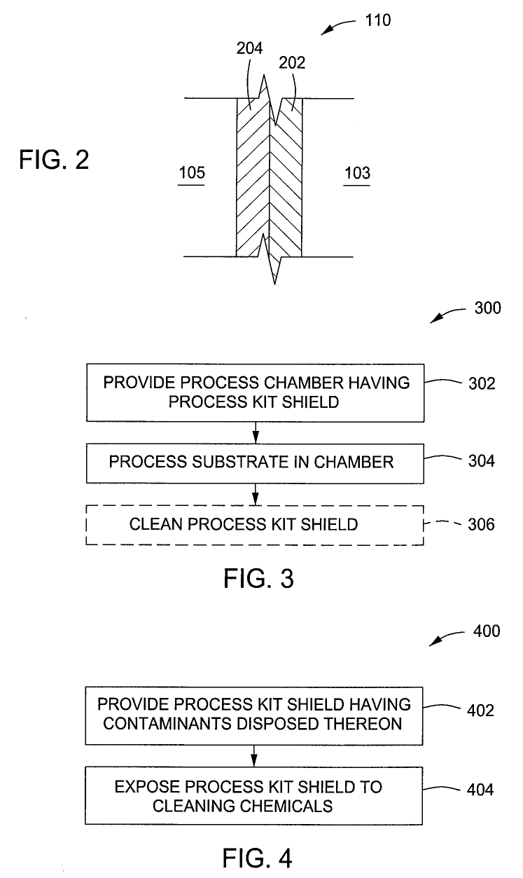

The process kit shield 110 may generally include a body having a wall as depicted in FIG. 1. As shown in detail in FIG. 2, the wall of the process kit shield 110 comprises a first layer 202 formed from a first material and a second layer 204 formed from a second material. The first layer 202 is configured to face the processing volume 103 and the second layer 204 is configured to face the non-processing volume 105. In the embodiment shown in FIG. 1, the first layer 202 may be an inner, or inward facing layer, and the second layer 204 may be an outer, or outward facing layer.

By providing the process kit shield 110 with a wall having a first material facing the process volume 103 and a second material shielded from the process volume, the process kit shield 110 may be fabricated from different materials that work together to provide an improved functionality over conventional process kit shields. For example, the first layer 202 may provide one or more of: resistance to the process chamber process conditions (e.g., chemistry, plasma, and the like); ability to be textured by mechanical means (e.g., blasting, machining, forming, laser, e-beam, and the like); and/or chemical resistance to deposition removal (e.g., stripping chemistry, blasting, or the like). In addition, the second layer 204 may provide one or more of: high thermal conductivity (e.g., to facilitate rapid cooling and/or heating), thermal expansion coefficient matching to process side shield (e.g., the first layer 202), electrical conductivity, magnetic properties, and/or low weight.

In some embodiments, the first layer 202 may comprise a material that is resistant to the processing environment—e.g., the materials, chemicals, plasmas, or the like, to which the first layer 202 will be exposed during processing and/or cleaning. As such, the first material may be adapted for improved resistance to, for example, hydrofluoric acid (HF) and other caustic chemicals utilized in cleaning processes to remove deposited materials from the process kit shield. In some embodiments, the first material includes at least one of stainless steel, nickel, tantalum or titanium, or the like.

In some embodiments, the first layer 202 may also include a textured surface for retaining particles and/or layers formed from particles, such as those sputtered from the target 104 or otherwise deposited on the surface of the first layer 202. The textured surface may generally be capable of retaining deposition layers and not shedding particles. In some embodiments, the textured surface may be capable of retaining particles having diameters greater than or equal to about 0.009 microns. In some embodiments, the textured surface may be capable of retaining particles having diameters greater than or equal to about 0.016 microns. The textured surface may be formed by texturing processes such as blasting, machining, laser or e-beam etching, or the like. For example, an inner, or process-facing surface of the first layer 202 may be textured by forming over a die, machining, arc spraying, anodizing, chemical texturing, LAVACOAT® or CLEANCOAT™ processing, and/or by cleaning and texturing, thereby facilitating process transparency when utilizing process kit shields of the present invention.

The second layer 204 is not directly exposed to the processing environment and, as such, generally may be fabricated from any suitable materials. In some embodiments, the second layer 204 may be fabricated from a second material adapted for providing a low weight, high thermal conductivity, high electrical conductivity, magnetic shielding, a CTE that closely matches that of the first layer 202, or combinations thereof. The second material may be any suitable material for providing one or more of the above characteristics. For example, in some embodiments, the second material may be an aluminum and silicon composite material. The aluminum silicon composite material may advantageously provide the high thermal conductance of aluminum while also allowing a modification of the CTE of the material by controlling the silicon content. For example, the CTE may be adjusted in a range of between about 5 to about 22 (corresponding to pure aluminum), thereby facilitating the matching of the CTE of the second material to that of numerous first materials suitable for forming the first layer 202.

Fabricating the second layer 204 from materials having a high thermal conductivity may facilitate maintaining a lower temperature of the process kit shield 110, thereby facilitating reduction in thermal swings that may cause flaking of materials deposited on the shield. The lower temperature of the process kit shield 110 may also lead to reduced particle formation on the surface of the shield, thereby extending the mean time between cleaning of the process kit shield. For example, the inventors have discovered that, running an exemplary deposition process, a process kit shield fabricated completely from stainless steel may heat up to a temperature as high as 600 degrees Celsius. However, a process kit shield fabricated completely from aluminum maintains a temperature of about 80 degrees Celsius during the same process. Thus, by providing the process kit shield 110 of the present invention with a process facing first layer comprising, for example stainless steel, and a second layer comprising aluminum and silicon, the chemical resistance of the first layer materials may advantageously be combined with the capability of running at reduced temperatures, thereby reducing the deposition rate of materials on the process kit shield in some processes, for example, a CVD process. In some embodiments, the temperature of the process kit shield achieved during processing may be between about 100 to about 200 degrees Celsius.

In addition, matching of the CTE between the first layer 202 and the second layer 204 facilitates maintaining a robust bond therebetween. By matching the CTE of the first layer 202 with that of the second layer 204, the stress at the bond interface of the layers will not be high enough to destroy the bond. Properly bonded first and second layers 202, 204 will also prevent virtual leaks and provide process transparency to current solid aluminum shields. For example, the first layer 202 is coupled or bonded to the second layer 204, thus integrally forming the wall of the process kit shield 110. The first and second layers 202, 204 may be formed and bonded together in any suitable fashion for forming an integral bond between the layers, for example, by providing cylindrical materials that may be press fit together, spray coating a material (either the process-facing first material, or the second material) on a surface of another material, magneforming a powder of a material (either the process-facing first material, or the second material) on a surface of another material, or the like.

To facilitate maintaining a robust bond between the first layer 202 and second layer 204 to withstand processing conditions (such as, for example, elevated temperatures), the first and second materials may be selected to have a similar CTE. In some embodiments, the difference between the CTE of the first and second material is less than about 10 percent. In some embodiments, the difference between the CTE of the first and second material is less than about 3 ppm/degree Celsius. For example, in some embodiments, the first material may be stainless steel, which has a CTE of about 14-16, and the second material may be an aluminum-silicon alloy, which, by controlling the silicon content, may also have a CTE of about 14-16.

In addition to the selection of the first material and the second material for the reasons discussed above, the first material and/or the second material may also be selected to provide other benefits, such as the ability to pass, mitigate, or shield a magnetic field from within the processing volume 103, for conductive and/or non-conductive properties, or the like. In addition, although depicted in FIG. 2 as comprising two layers, the process kit shield 110 may comprise more than two layers, with the CTE of each layer closely matched. For example, a shield having more than two layers may be utilized to provide thermal conductivity, magnetic shielding, electrical conductivity, reduced CTE mismatch between adjacent layers, and/or chemical resistance where each layer provides at least some of the desired characteristics such that the process kit shield as a whole provides all desired characteristics.

Returning to FIG. 1, a process gas supply 114, which includes a process gas source 116 and a first mass flow controller 120, supplies a process gas (for example, argon) to the process chamber 102. If reactive sputtering is to be performed to sputter-deposit a metal nitride layer, such as TaN, a second gas supply 118 may be provided, including a nitrogen gas source 122 and a second mass flow controller 126. The process chamber 102 is shown as receiving argon and nitrogen near the top of the chamber 102, but may be reconfigured to receive such gases at other locations, such as near the bottom of the process chamber 102. A pump 124 is provided to pump out the process chamber 102 to a pressure at which sputtering is performed; and an RF power source 130 is connected to the pedestal 108 through a coupling capacitor 132 (e.g., for biasing the substrate 106 during sputtering).

To promote efficient sputtering, a magnetron 134 may be rotationally mounted above the target 104 to shape the plasma. The magnetron 134 may be of a type which produces an asymmetric magnetic field which extends deep into the chamber 102 (e.g., toward the pedestal 108), to enhance the ionization density of the plasma, as disclosed in U.S. Pat. No. 6,183,614. U.S. Pat. No. 6,183,614 is incorporated herein by reference in its entirety. In some embodiments, ionized metal densities may reach 10¹⁰ to 10¹¹ metal ions/cm³ (e.g., in a bulk region of the plasma) when such asymmetric magnetic fields are employed. In such systems, ionized metal atoms follow the magnetic field lines which extend into the chamber 102, and thus coat the substrate 106 with greater directionality and efficiency. The magnetron 134 may rotate, for example, at 60 to 100 rpm. In other embodiments, stationary magnetic rings may be used instead of the rotating magnetron 134.

A controller 128 is provided to control operation of the chamber 102. The controller 128 generally comprises a central processing unit (CPU), a memory, and support circuits (not shown). The controller 128 is coupled to control modules and apparatuses of the chamber 102. In operation, the controller 128 directly controls modules and operations of the apparatus 100 or, alternatively, administers computers (and/or controllers) associated with these modules and apparatuses. The controller 128 is operatively connected to control the DC power supply 112, the first mass flow controller 120, the second mass flow controller 126, the pump 124, and the RF power supply 130. Similarly the controller 128 may be coupled to control the position and/or temperature of the pedestal 108. For example, the controller 128 may control the distance between the pedestal 108 and the target 104, as well as heating and/or cooling of the pedestal 108. The controller 128 may, for example, direct the process chamber to perform a method for processing a substrate in the process chamber as discussed below with reference to FIG. 3.

FIG. 3 depicts a flow chart of a method for processing a substrate in accordance with some embodiments of the present invention. The method 300 is described below with respect to the apparatus 100 and process kit shield 110 of FIGS. 1-2.

The method 300 begins at 302, where a process chamber 102 is provided having a process kit shield 110. The process kit shield 110 may separate the processing volume 103 of the process chamber 102 from the non-processing volume 105 as discussed above.

At 304, a substrate 106 is processed in the processing volume 103 of process chamber 102. For example, in an illustrative PVD process, processing may begin by introducing argon into the processing volume 103 from the process gas supply 114 and supplying power from the DC power supply 112 to ignite the argon to form a plasma. Positive argon ions generated in the plasma are attracted to the negatively charged target 104, and may strike the target 104 with sufficient energy to cause target atoms to be sputtered from the target 104. Some of the sputtered atoms strike the substrate 106 and are deposited thereon, thereby forming a film of the target material on the substrate 106.

During processing of the substrate 106 sputtered or ionized target atoms in the processing volume 103, as well as other processing byproducts, can be deposited on the surface of the first layer 202 of the process kit shield 110 facing the processing volume 103. The deposited material may be formed on the surface of the first layer 202 to a thickness sufficient to result in flaking and contamination of substrate 106 during processing. In some embodiments, to extend the mean time between cleaning and further reduce contamination of the substrate, the process-facing surface of the first layer 202 may be textured and capable of retaining particles having diameters greater than about 0.016 microns. The textured surface may facilitate more even distribution and/or improved retention of material disposed on the surface of the first layer 202.

At 306, upon deposition of materials on the surface of the first layer 202, the process kit shield 110 to a sufficient thickness, the process kit shield 110 may require cleaning to remove the deposited materials prior to continued use in the processing chamber. By providing a process kit shield 110 in accordance with the present invention, the number of cleaning processes may be increased, for example, from about four cleaning cycles of a conventional process kit shield to up to about 20 cleaning cycles of a process kit shield in accordance with the present invention. The ability to withstand an increased number of cleaning cycles advantageously lengthens the lifetime of the process kit shield of the present invention.

For example, FIG. 4 depicts a flow chart of an illustrative method 400 for cleaning the process kit shield 110 in accordance with some embodiments of the present invention. The method 400 is described below with respect to the apparatus 100 and process kit shield 110 of FIGS. 1-2. The cleaning process may be performed in-situ or ex-situ, depending on the capabilities of the process chamber for supplying appropriate process gases for cleaning. For example, an in-situ cleaning process may be performed in process chambers which use a reactive ion etch (RIE), or suitable plasmas formed from a cleaning chemistry (such as ozone (O₃) or oxygen (O₂)) to clean the chamber and/or chamber components. The cleaning process may be performed at any suitable time where cleaning is required.

At 402, the process kit shield 110 is provided having contaminants disposed on the surface of the first layer 202. The contaminants may include at least one of target atoms or byproduct materials as described above.

At 404, the process kit shield 110 is exposed to a cleaning chemistry. In some embodiments, the only the first layer 202 is exposed to the cleaning chemistry, thereby protecting the second layer 204 from exposure. In some embodiments, the entire process kit shield 110 may be exposed to the cleaning chemistry. The cleaning chemistry may include at least one of hydrofluoric acid (HF), nitric acid (HNO₃), hydrogen peroxide (H₂O₂), ammonium (NH₄), potassium hydroxide (KOH) or other caustic chemicals suitable for removing the aforementioned contaminants.

For in-situ cleaning (i.e., in the process chamber) the cleaning chemical may be introduced in a gaseous form and contact the first layer 202 of the process kit shield 110. Residual cleaning chemical and byproducts formed from the interaction of the cleaning chemical with the contaminants may be exhausted via an exhaust port or other means form removing gases from a process chamber.

For ex-situ cleaning, the process kit shield 110 is removed from the process chamber 102, and may be cleaned in any of a number of suitable methods in which the first layer 202 is exposed to the cleaning chemistry, thus removing the contaminants from the surface of the first layer 202. For example, the process kit shield 110 may be dipped in a bath containing the cleaning chemistry or may be exposed to manual or automated spray application of the cleaning chemistries. In some embodiments, the surface to be cleaned may be wetted with the cleaning chemistries and wiped or scrubbed with a cloth and/or scrubbing pad, or the like. It is contemplated that other suitable ex-situ cleaning methods may also be utilized to remove the contaminants disposed on the surface of the first layer 202.

Thus, methods and apparatus for a process kit shield are provided herein. The inventive process kit shield may advantageously have an increased lifetime as compared to conventional process kit shields while also providing superior thermal properties and weight advantages. The inventive process kit shield may be constructed from a combination of materials providing the desired weight, thermal properties, and resistance to chemical cleaning treatments.

While the foregoing is directed to embodiments of the present invention, other and further embodiments of the invention may be devised without departing from the basic scope thereof, and the scope thereof is determined by the claims that follow.

1. A process kit shield, comprising:
a body having a wall comprising a first layer and a second layer bonded to the first layer, wherein the first layer comprises a first material resistant to a cleaning chemistry utilized to remove material disposed on the first layer during processing, and wherein the second layer comprises a second material different than the first material and having a coefficient of thermal expansion substantially similar to that of the first material.

2. The process kit shield of claim 1, wherein the difference between the coefficients of thermal expansion of the first and second materials is less than or equal to about 10 percent.

3. The process kit shield of claim 1, wherein the second layer is spray formed onto the first layer.

4. The process kit shield of claim 1, wherein the body is annular.

5. The process kit shield of claim 1, wherein the first material comprises at least one of stainless steel, nickel, tantalum or titanium.

6. The process kit shield of claim 1, wherein the second material comprises aluminum and silicon.

7. The process kit shield of claim 1, wherein the first layer comprises a textured process-facing surface capable of retaining particles having diameters greater than about 0.016 microns.

8. An apparatus for processing a substrate, comprising:
a process chamber having a processing volume and a non-processing volume; and
a process kit shield disposed in the chamber and separating the processing volume from the non-processing volume, the process kit shield comprising a body having a wall comprising a first layer that faces the processing volume and a second layer that faces the non-processing volume, wherein the second layer is bonded to the first layer, wherein the first layer comprises a first material resistant to a cleaning chemistry utilized to remove material disposed on the first layer during processing, and wherein the second layer comprises a second material different than the first material and having a coefficient of thermal expansion substantially similar to that of the first material.

9. The apparatus of claim 8, wherein the process kit shield circumscribes a substrate support pedestal disposed in the process chamber beneath the processing volume.

10. The apparatus of claim 8, wherein the second layer is spray formed onto the first layer.

11. The apparatus of claim 8, wherein the difference between the coefficients of thermal expansion of the first and second materials is less than or equal to about 10 percent.

12. The apparatus of claim 8, wherein the first material comprises at least one of stainless steel, nickel, tantalum or titanium.

13. The apparatus of claim 8, wherein the second material comprises an alloy of aluminum and silicon.

14. The apparatus of claim 8, wherein the first layer comprises a textured process-facing surface capable of retaining particles having diameters greater than about 0.016 microns.

15. A method of processing a substrate, comprising:
providing a process chamber having a processing volume and a non-processing volume and having a process kit shield disposed in the chamber and separating the processing volume from the non-processing volume, the process kit shield comprising a body having a wall comprising a first layer that faces the processing volume and a second layer that faces the non-processing volume, wherein the second layer is bonded to the first layer, wherein the first layer comprises a first material resistant to a cleaning chemistry utilized to remove material disposed on the first layer during processing, and wherein the second layer comprises a second material different than the first material and having a coefficient of thermal expansion substantially similar to that of the first material;
placing a substrate in the process chamber;
forming a plasma in the processing volume; and
exposing the substrate to the plasma.

16. The method of claim 15, wherein the difference between the coefficients of thermal expansion of the first and second materials is less than or equal to about 10 percent.

17. The method of claim 15, wherein the first layer further comprises a textured surface capable of retaining particles having diameters greater than about 0.016 microns.

18. The method of claim 17, wherein the retained particles include at least one of byproducts formed from processing the substrate or ionized particles formed in the plasma.

19. A method of cleaning a process kit shield, comprising:
providing a process kit shield comprising a body having a wall comprising a first layer and a second layer bonded to the first layer, wherein the first layer comprises a first material resistant to a cleaning chemistry utilized to remove material disposed on the first layer during processing, wherein the second layer comprises a second material different than the first material and having a coefficient of thermal expansion substantially similar to that of the first material, and wherein the first layer has contaminants disposed thereon; and
exposing the first layer to the cleaning chemistry to remove the contaminants.

20. The method of claim 19, wherein the difference between the coefficients of thermal expansion of the first and second materials is less than or equal to about 10 percent.

21. The method of claim 19, wherein the first material comprises at least one of stainless steel, nickel, tantalum or titanium.

22. The method of claim 19, wherein the second material comprises aluminum and silicon.

23. The method of claim 19, wherein the cleaning chemistry comprises at least one of hydrofluoric acid (HF), nitric acid (HNO₃), hydrogen peroxide (H₂O₂), ammonium (NH₄), or potassium hydroxide (KOH).

24. The method of claim 19, wherein only the first layer is exposed to the cleaning chemistry.
